(19) United States
(12) Patent Application Publication
(10) Pub. No.: US 2004/0101240 A1
(43) Pub. Date: May 27, 2004

(54) Method to reduce birefringence and polarization mode dispersion in fiber gratings

(75) Inventor: Nirmal K. Viswanathan, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/301,301

(22) Filed: Nov. 21, 2002

(51) Int. Cl. G02B 6/34

(52) U.S. Cl. 385/37

(57) ABSTRACT

Side-writing a refractive structure, such as a grating, into a waveguide results in an asymmetry in the induced refractive index change and a preferential orientation of dipolar defects, that leads to birefringence and polarization mode dispersion (PMD) in the refractive structure. Illumination of the structure to photo-reduce and to randomize UV-absorbing defects in the waveguide results in a reduction of the birefringence and the PMD.

### FIELD OF THE INVENTION

The present invention is directed to optical waveguides, and more particularly to an approach for reducing the birefringence and polarization mode dispersion in refractive structures, such as gratings, formed in optical waveguides.

### BACKGROUND

Changes in the refractive index of photosensitive optical fibers can be inscribed by exposing the fiber, usually the fiber core, but also the cladding in some circumstances, to UV radiation. Where the illuminating UV radiation has a periodic nature, the resultant change in the fiber's refractive index is also periodic, resulting in the inscription of a grating. Examples of such gratings include fiber Bragg gratings (FBGs) and long period gratings (LPGs).

The photosensitive fiber is often written with UV illumination from the side of the fiber, in the direction perpendicular to the fiber axis. Since the UV light is exponentially absorbed within the photosensitive fiber, side-illumination results in a change in the fiber's refractive index that is non-uniform across the fiber. Further, the orientation of the dipole moments of the defects created by the UV illumination can increase depending on the polarization of the light used to write such gratings. These two sources of asymmetry, the non-uniform refractive index profile and the preferential dipole orientation, lead to birefringence in the fiber, which may result in different spectral responses for orthogonal polarizations of waveguided light that is incident on the grating. This may also lead to polarization mode dispersion (PMD) in FBG's due to the different group delays (DGDs) for orthogonal polarizations. PMD is particularly a problem for chirped gratings as it significantly affects the performance of high-speed single-mode fiber optical communication network systems.

### Summary of the Invention

There is a need to address the problems of UV-induced birefringence and PMD. In particular, there is a need to reduce the UV-induced birefringence and PMD of UV-inscribed refractive structures in waveguides, for example FBGs and LPGs formed in optical fibers.

A Method in accordance with the present invention is directed to illuminating the UV exposed region of the waveguide with light, typically visible or infrared light, to reduce the UV-induced birefringence and the PMD of the UV-inscribed structures. In one particular embodiment, the invention is directed to a method for reducing the birefringent characteristics of a refractive structure written in a waveguide. The method includes providing the waveguide with the refractive structure written in the waveguide, the refractive structure having an associated germanium-related defect. The method also includes exposing the refractive structure to photo-reducing light absorbable by the germanium-related defect and having a sufficient intensity so as to reduce a birefringent characteristic of the refractive structure.

Another embodiment of the invention is directed to an optical waveguide device formed from an optical waveguide. A refractive structure is written in a portion of the waveguide containing a photosensitive species. The refractive structure is birefringence-reduced using photo-reducing light.

Another embodiment of the invention is directed to an optical waveguide device that includes an optical waveguide. A chirped Bragg grating in the waveguide has a bandwidth of at least 1 nm and a polarization mode dispersion of not more than 1 ps.

Another embodiment of the invention is directed to an optical communications system that has an optical transmitter transmitting output light, and a fiber optic link coupled to carry the output light from the optical transmitter. A waveguide having a grating is coupled to the fiber optic link to reflect at least a portion of the output light. The grating includes a refractive structure written in a portion of the waveguide containing a photosensitive species. The refractive structure is birefringence-reduced using photo-reducing light.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates one approach to UV writing a grating in an optical fiber;

FIG. 2 schematically illustrates an apparatus useful for measuring birefringent effects in an optical fiber;

FIG. 3 presents curves showing the transmission loss in a fiber before and after being exposed to photo-reduction according to an embodiment of the present invention;

FIG. 4 schematically illustrates an embodiment of an apparatus used for photo-reducing birefringent effects in an optical waveguide;

FIG. 5 presents curves showing transmission loss through a fiber for several different durations of exposure to the photo-reducing light;

FIG. 6 presents a graph showing measured birefringence as a function of exposure time;

FIG. 7 presents curves showing the transmission loss through the fiber after being exposed to photo-reducing light of different polarization states;

FIGS. 8A and 8C present topographic images of an optical fiber, obtained using an atomic force microscope, before and after exposure to the photo-reducing light;

FIGS. 8B and 8D present cross-sectional measurements of an optical fiber, obtained using an atomic force microscope, before and after exposure to the photo-reducing light;

FIG. 9 presents curves showing PMD for a grating before and after exposure to the photo-reducing light, using a first method of measuring PMD;

FIG. 10 presents a graph showing fractional reduction of PMD as a function of exposure pulse energy;

FIG. 11 presents curves showing PMD for a grating before and after exposure to the photo-reducing light, using a second method of measuring PMD;

FIG. 12 presents a graph showing reduction of PMD as a function of photo-reduction time;

FIG. 13 presents curves showing the change in absorption spectrum of the chirped fiber grating before and after exposure to the photo-reducing light; and

FIG. 14 schematically illustrates an embodiment of a communications system that includes a fiber grating according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical devices written into optical waveguides, such as optical fibers.

Refractive structures, for example gratings, are often inscribed in optical waveguides, such as optical fibers or planar waveguides, using UV light incident from the side of the waveguide. This method of illumination allows the periodicity of the structure written in the waveguide to be set at a selected value. There are, however, certain disadvantages associated with this method of writing the structure. First, since the UV light is exponentially absorbed across the waveguide, transverse illumination results in a change in the waveguide's refractive index that is non-uniform across the waveguide. Further, the orientation of the dipole moments of the defects created by the UV illumination can increase depending on the polarization of the light used to write such gratings. These two effects predominantly lead to an increase in the birefringence of the fiber grating, which is often undesirable. For example, the induced birefringence leads to different spectral responses for guided light in different polarization states that is incident on the structure. This may also lead to polarization mode dispersion (PMD) due to the different group delays for orthogonal polarizations.

The present invention is directed to the use of light, typically visible or infrared light, to illuminate the UV-inscribed region of the waveguide. It is believed that the light photo-reduces and randomizes the Ge-1 defects that result from UV-inscription of a refractive structure, thus reducing the birefringence and other birefringence-related characteristics. The term photo-reduction is used to refer to the process described herein where light, for example light in the visible and infra-red regions, is used to reduce the increased absorption, birefringence and PMD of a fiber grating due to asymmetrical exposure of the waveguide to UV light when the grating is written.

In several of the illustrative examples discussed below, the technique is directed to reducing the birefringence and PMD of a chirped fiber grating (CFG). The selection of illustrative examples is not intended to imply any limitations to the use of the technique, and it will be appreciated that the invention may be used for other types of grating, or indeed any other type of UV-inscribed structure, in a fiber. Furthermore, the invention is not limited to use in only fiber waveguides, but may also be used in other types of waveguides, for example planar waveguides.

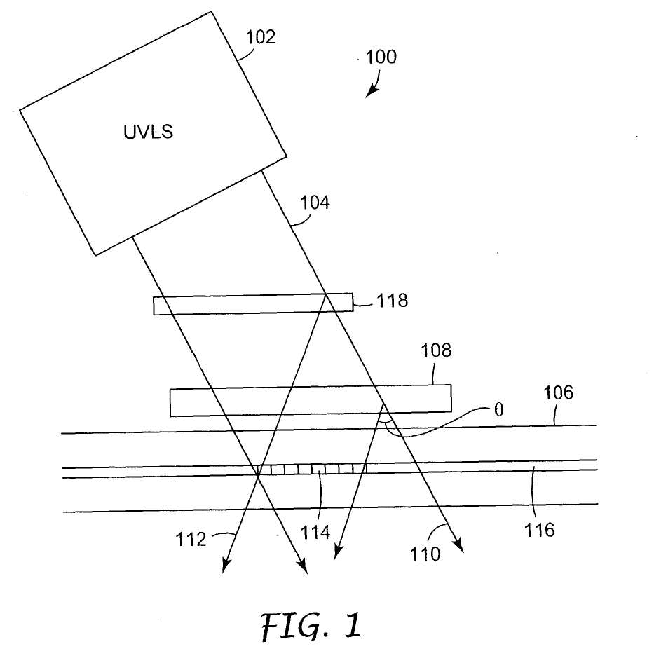

One particular embodiment of a system 100 for UV-inscribing a grating structure into a fiber waveguide is schematically illustrated in FIG. 1. The system includes a UV light source (UVLS) 102 that generates a conditioned light beam 104 at a wavelength suitable for exposing a pattern in the photosensitive fiber 106. The UVLS 102 may include, for example, an ultraviolet laser such as a Kr*F excimer laser or a frequency doubled Ar⁺ laser, along with optical systems for uniformizing the beam intensity profile. The conditioned beam 104 is incident on a phase mask 108, which transmits a zero-order beam 110 and diffracts a minus first order beam 112. The two beams 110 and 112 interfere, causing an interference pattern 114 in the photosensitive fiber 106. In the particular embodiment illustrated, the fiber 106 has a photosensitive core 116. It will be appreciated that the fiber 106 may have a photosensitive core and/or a photosensitive cladding. Exposure of the photosensitive core 116 to the interference pattern 114 results in writing a refractive index grating in the core 116. The light 104 is typically line focused by a cylindrical lens 118 onto the fiber 106.

The phase mask 108 includes a diffracting structure that sets the angle, θ, between the two beams 112 and 114 to have a selected value, so as to set the periodicity of the resulting fiber grating written in the fiber 106.

It will be appreciated that other approaches may be used to write a fiber grating. For example, an interference pattern may be created by first splitting a UV light beam into two beams using a beamsplitter and then overlapping the resulting two beams so as to interfere in the fiber core. Additional approaches that may be used for writing refractive index structures into waveguides, particularly fibers, are described in U.S. Pat. Nos. 5,912,999, 6,035,083 and 6,404,956, incorporated herein by reference.

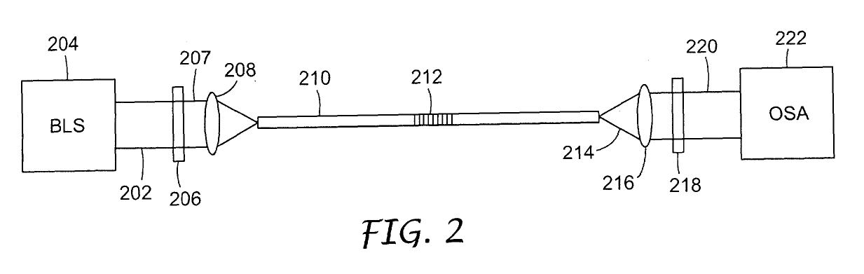

One particular method useful for determining birefringent effects in an optical waveguide that arise from side-writing a refractive structure is the so-called “fixed analyzer method,” schematically illustrated in FIG. 2. Light 202 from a broadband light source (BLS) 204 is passed through a polarization control unit 206, for example a polarizer, a retardation waveplate, or a combination of both. The polarization control unit 206 is used to select a particular polarization state for the light 207 that enters the fiber 210. The light is then focused into the optical fiber 210 under test using a lens system 208 having one or more lenses. The fiber 210 includes a UV-inscribed structure 212, such as a grating. The broadband light source 204, for example a white light source AQ-4303 B from Ando Electric Co., Ltd. Tokyo, Japan, typically emits over a large bandwidth, for example 0.4 μm-1.8 μm.

The light 214 output from the fiber 210 may first be collected by a condensing lens system 216 and then passed through a polarization analyzer 218. The polarized light 220 is then passed into a detector system 222 that detects the throughput from the analyzer 218 as a function of light wavelength. The detection system 222 may be, for example, an optical spectrum analyzer (OSA), such as a model AQ-6315A from Ando Electric Co., Ltd. Tokyo, Japan, having a measurement wavelength range from 0.35 μm-1.75 μm. The relative orientation of the transmission axis of the analyzer 218 and the polarization direction of the light 207 may be set to any angle so as to maximize the contrast of the spectral fringes recorded at the output.

When the fiber 210 is birefringent, predominantly due to the UV-inscribed structure 212, a linearly polarized light launched, for example at 45° to the birefringence axis, is split into orthogonal components upon transmission. Upon exiting the fiber 210, the polarization analyzer 218 orientated either parallel or perpendicular to the polarizer 206 allows the superposition of the two orthogonal electric field components in equal magnitude as propagated in the fiber 210. This results in high-contrast fringes due to interference in the spectral domain. From the measured interference spectra the birefringence can be calculated using Δn=λ²/(dλ L), where, d) is the period of the interference fringe, λ is the wavelength and L is the length of the UV-exposed fiber.

### EXAMPLE 1

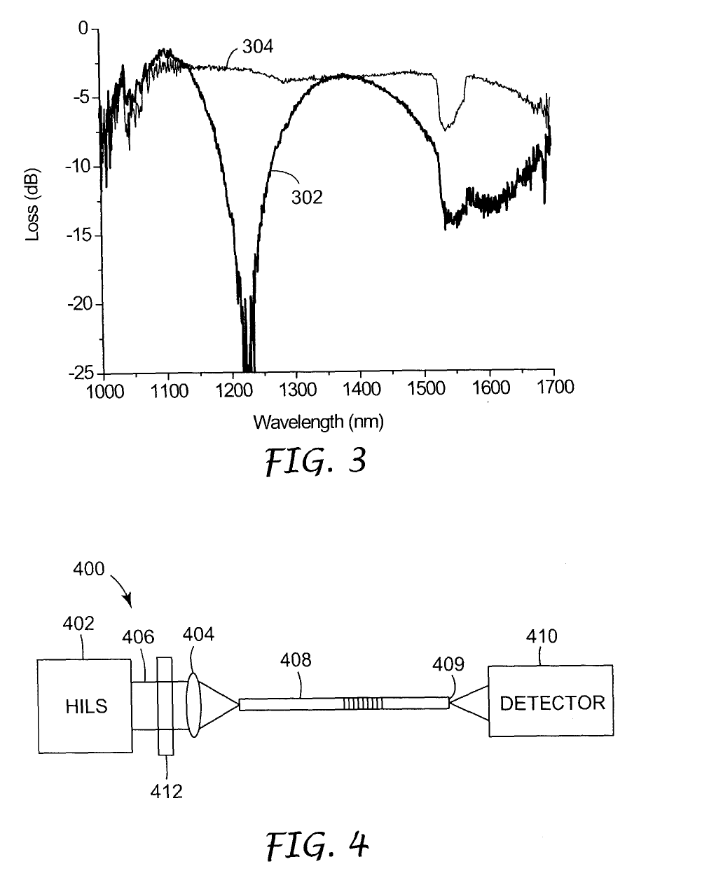

The intrinsic birefringence of a 50 m length of pristine 3M TF19 photosensitive fiber was measured to be approximately 1.16×10⁻⁷. A CFG having a length of 1.24 m was UV-inscribed in the fiber by side-writing with a UV light beam. The resulting transmission spectrum, obtained using a system as illustrated in FIG. 2, is shown as curve 302 in FIG. 3. The spectrum measured prior to photo-reduction, curve 302, shows transmission peaks at around 1100 m and 1350 m-n, suggesting a fringe periodicity of about 250 nm. This corresponds to a value of birefringence of approximately 4.37×10⁻⁶ across the measured wavelength range.

An example of a photo-reduction system 400 that may be used for photo-reducing the UV-induced birefringence of the fiber is schematically illustrated in FIG. 4. The system 400 includes a light source 402, typically a laser, and a focusing lens system 404. In the illustrated embodiment, the focusing system 404 focuses the light 406 from the high intensity light source (HILS) 402 into the fiber 408, so that the light 406 coupled into the fiber 408 is guided along the fiber core over the length of the fiber 408 at relatively high intensity. The intensity or the energy of the light guided through the fiber core is measured using a detector 410 at the output of the fiber 409.

In another approach, the light 406 is not guided by the fiber 408, but is incident on the fiber 408 from the side.

The light source 402 may be, for example, any suitable laser that generates high average power or high pulse energy. For example, the light source 402 may be a Q-switched Nd:YAG laser, or a pulsed optical parametric oscillator, such as a Nd:YAG-pumped XPO laser (Infinity-XPO laser, Coherent, Inc. CA) laser or a cw ion laser.

A polarization control element 412 may be positioned between the light source 402 and the fiber 408. The polarization control element 412 may include, for example, a waveplate to rotate the direction of polarized light produced by the light source, or to change the polarization state from linear to elliptical or circular, or vice versa. The polarization controller 412 may also include a depolarizer to scramble the polarization of the light received from the light source 402 or may include a polarizer to polarize unpolarized light received from the light source 402.

The 3M TF19 photosensitive fiber used to generate the data for curve 302 in FIG. 3 was exposed to high-intensity, linearly polarized light. The optical intensity in the fiber was calculated to be a few MW/cm², using the value of the energy of the light guided through the core and the core diameter. The light source was a Q-switched Nd:YAG pumped XPO laser (Infinity-XPO laser, Coherent, Inc. CA) operating at 10 Hz, and generating 5 ns pulses at a wavelength of 532 nm. The light was focused axially into the core of the fiber, and the fiber was exposed to the XPO-laser light for about 15 minutes.

The spectrum measured after the exposure, curve 304, shows an almost complete erasure of the UV-induced birefringence. The characteristics of the grating, which are manifested as a loss peak centered at around 1550 nm, were substantially preserved during the photo-reduction process. The erasure of UV-induced birefringence was further verified by rotating the polarizer 206 and analyzer 218 angles for any possible rotation in the birefringence axis of the fiber 210 during exposure to polarized visible radiation.

It is believed that the birefringence that results from UV-writing a refractive structure in a waveguide arises predominantly from the presence of Ge-1 defects, which has maximum absorption around 280 nm with the absorption tail extending into the visible and near infrared wavelength regions. Illumination of the written waveguide with light absorbable by this defect results in photo-reducing the absorption band, with a concomitant reduction in the UV-induced absorption loss.

Light may be absorbed by the Ge-1 defect in a single photon absorption process. Such light, however, lies in the UV region and is strongly absorbed by the Ge present in the waveguide, and therefore is better suited to illuminating the waveguide from the side than illuminating the waveguide by propagating along the core. Light having a longer wavelength may be absorbed by the defect via a multi-photon absorption process. Since it is not absorbed as strongly by the Ge in the waveguide, such light is well-suited to illuminating the waveguide by propagating along the waveguide core, so long as its wavelength is less than the cut-off wavelength of the waveguide. For example, the wavelengths used in the examples described here, 514.5 nm, 532 nm and 650 nm, are absorbed via a two-photon absorption process. Other wavelengths may also be used, for example in a three or four-photon absorption process. Additionally, the waveguide may be illuminated by two or more wavelengths of light, with the Ge-1 defect absorbing one or more photons at each of the different wavelengths.

### EXAMPLE 2

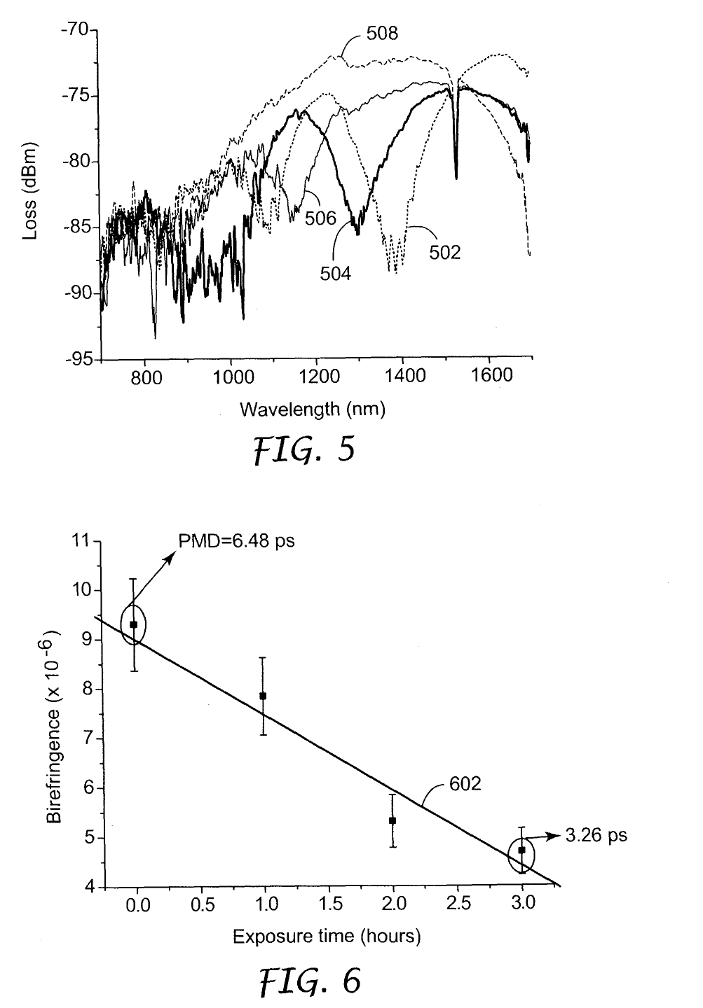

Another experiment was carried out using a cw Ar⁺ ion laser operating at λ=514.5 nm to illuminate the fiber core containing the inscribed grating. A fixed laser power of 500 mW was used in this example. The light produced by the laser was linearly polarized, and a quarter wave retardation plate was placed between the laser and the fiber to circularly polarize the light before entering the fiber core. The spectral fringes were measured as a function of time using a system as illustrated in FIG. 2. The transmission fringe spectra thus measured are illustrated as different curves in FIG. 5. Curve 502 represents the transmission measured before the fiber, inscribed with a grating, was illuminated with the Ar⁺ laser. Curves 504, 506 and 508 represent the loss measured after 1 hour, 2 hours and 3 hours respectively.

As the number of interference fringes is proportional to the UV-induced birefringence, it is clearly seen from FIG. 5 that the number of fringes, and hence the birefringence decreases with exposure time for a fixed laser power of approximately 500 mW. The birefringence was calculated as a function of exposure time, and is plotted as curve 602 in FIG. 6. The calculated value of birefringence is shown, along with the associated error, for each exposure time. The curve 602 represents the best linear fit to the data points.

The PMD of the grating, calculated using (DλΔn/n_{eff}) where D is the dispersion of the grating (650 ps/nm), was calculated for the fiber before being exposed and after being exposed for three hours. Before exposure, the PMD was 6.48 ps, which reduced to 3.26 ps after 3 hours, showing a reduction of approximately a factor of two under these illumination conditions.

### EXAMPLE 3

This example describes an attempt to verify one of the mechanisms of photo-reduction of the UV-induced birefringence in the fiber—the effect of dipole orientation of the UV-induced Ge-1 defects. One of the main sources of UV-induced birefringence is thought to be an anisotropy that arises when dipole moments are created when the 240-nm absorption band is bleached with polarized UV light during the grating writing process. This anisotropy, due to preferential orientation of the dipoles, is expected to give rise to birefringence when it lies in a plane perpendicular to the light propagation direction and has little or no effect when it is parallel to the propagation direction of the guided light. The preferential orientation of the dipoles created during exposure to polarized UV light can be randomized by either launching a circularly or depolarized polarized light through the fiber core. This effectively reduces the birefringence of the fiber.

To demonstrate this first a linearly polarized light beam from the cw Ar⁺ laser having a power of 500 mW was launched into the fiber core. The 3M TF19 photosensitive fiber used had a CFG having a bandwidth of 14.7 nm and was written with a dispersion of 1600 ps/nm, corresponding to the UV-exposed fiber length of 2.44 m.

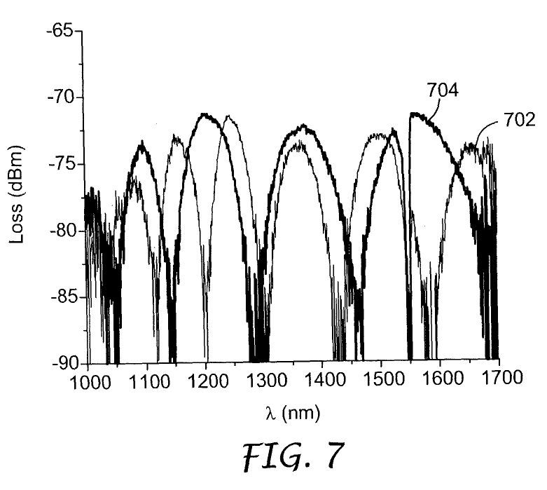

The birefringence spectrum was measured, curve 702 in FIG. 7, from which the birefringence was calculated to be approximately 6×10⁻⁶. The fiber was then exposed to circularly polarized light at a power level of 500 mW in the fiber core, for duration of 120 mins. The birefringence spectrum was measured again, curve 704, from which the birefringence was measured to be about 4.5×10-6. The level of birefringence could be reduced further either by increasing the exposure time or the launch power of the laser.

The results illustrated in FIG. 7 suggest that the dipole orientation of UV-induced defects acts as a possible mechanism for birefringence in the UV-inscribed structures. Randomizing the preferential dipole orientation by exposure to circularly polarized light significantly reduces the UV-induced birefringence.

### EXAMPLE 4

This example discusses another possible mechanism responsible for the UV-induced birefringence—geometrical asymmetry in the refractive index profile of the fiber core due to the UV exposure process. Cross-sections of the UV-exposed fibers are profiled using an atomic force microscope (AFM) after cleaving the fiber in the exposed region and etching the cleaved end face using dilute hydrofluoric acid (HFA) for a short time. The UV exposure results in differential etching at the side exposed to the UV light. Exposing the core of the UV-exposed fiber to photo-reducing visible radiation significantly reduces the UV-induced asymmetry and hence reduces the birefringence.

To demonstrate the AFM process, a 3M TF19 photosensitive fiber, written with a grating, was measured before and after treatment with the photo-reducing radiation. A pulsed Nd:YAG laser operating at 532 nm with a core-launched pulse energy of 30 mJ was used to photo-reduce the defects in approximately 30 minutes. Both the UV-exposed and photo-reduced fibers were then cleaved and etched in fresh 48% HFA for approximately 5 seconds. The fibers were then rinsed with de-ionized water and dried using a compressed inert gas. The samples were then mounted in custom fabricated mini-vices and placed in the AFM for imaging. The AFM (Digital Instruments Dimension 5000 SPM) was used in the tapping mode. The probes used were Olympus OTESPA Silicon with a force constant of nominally 40 N/m and a radius of curvature <10 nm.

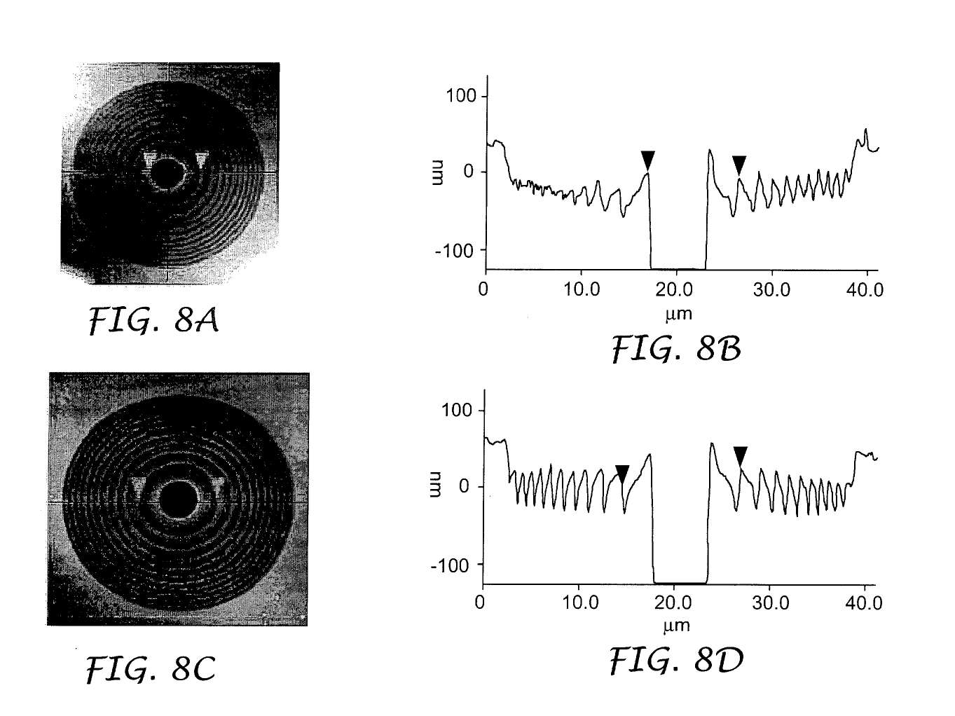

The AFM images of the fibers are shown in FIGS. 8A and 8C before and after the photo-reducing exposure respectively. FIGS. 8B and 8D present cross-sectional data for a slice across the fiber, before and after the photo-reducing exposure, respectively. It can be seen from these figures that the asymmetry in the fiber cross-section due to the UV exposure from one side is significantly reduced after exposure to the photo-reducing radiation. As mentioned before, this reduces the birefringence arising due to the geometrical asymmetry.

### EXAMPLE 5

The first-order polarization mode dispersion (PMD) of a chirped fiber grating is determined by the local birefringence of the fiber and the polarization mode coupling. The local birefringence of a fiber, however, is dominated by the UV-induced birefringence that arises from the grating writing process. The intrinsic birefringence of the fiber grating, before the grating is written, is about 10-7.

For a direct measurement of the reduction in the PMD due to the photo-reduction process, 18 identical chirped Bragg gratings (D 420 ps/nm, AS=1.5 nm and L is approximately 7 cm) were written using a system as disclosed in U.S. Pat. Nos. 5,912,999, 6,035,083 and 6,404,956. The bandwidth, A?, of a grating is defined as the range of wavelengths where the grating reflectivity is within 1 dB of the maximum grating reflectivity value.

The gratings were annealed at 120° C. to out-diffuse D₂ and to stabilize the index change. Chirped Bragg gratings are useful for compensating the dispersion on an optical signal that has propagated along a long length of optical fiber. Under normal dispersion, the longer wavelengths of the optical signal propagate faster than the shorter wavelengths of the signal, and so the pulse is stretched out, with longer wavelengths reaching the chirped Bragg grating earlier than the shorter wavelengths. The chirped Bragg grating is designed so that the longer wavelengths have to propagate further into the grating before being reflected, whereas the shorter wavelengths are reflected at the first portion of the grating. Accordingly, the shorter wavelengths propagate over a shorter path before being reflected than the longer wavelengths. The longer and shorter wavelength components of the signal are overlapped in the reflected pulse, and the pulse is compressed relative to the incoming pulse.

The grating characteristics were measured using an optical vector analyzer (OVA) 1550 (LUNA Technologies Inc., Blacksburg, Va., USA). The OVA uses interferometry to measure the necessary complex amplitudes and construct the Jones matrix, which contains all the parameters such as insertion loss, group delay, polarization dependent loss and polarization mode dispersion that characterize the device. The values of PMD for the gratings were verified by independent measurements made using a 4-point modulation phase-shift (MPS) technique.

Different exposure conditions were selected to study the effect of pulse energy and exposure time on the reduction in PMD due to the photo-reduction effect. A set of 3 gratings was used for each exposure condition in the study. Table I shows a summary of the different exposure conditions tested. The gratings were exposed to pulses of light at 532 nm coupled into the core from a Q-switched Nd:YAG pumped XPO laser (Infinity-XPO laser, Coherent, Inc. CA). The different exposure conditions represented different combinations of pulse energy coupled into the fiber core and the corresponding exposure time.

TABLE I
Summary of exposure conditions

| Pulse energy | | | | |
|---|---|---|---|---|
| Exposure time | 1 mJ | 5 mJ | 10 mJ | 30 mJ |
| 5 min. | ✓ | | ✓ | |
| 10 min. | | ✓ | | |
| 30 min. | ✓ | | ✓ | |
| 60 min. | | | | ✓ |

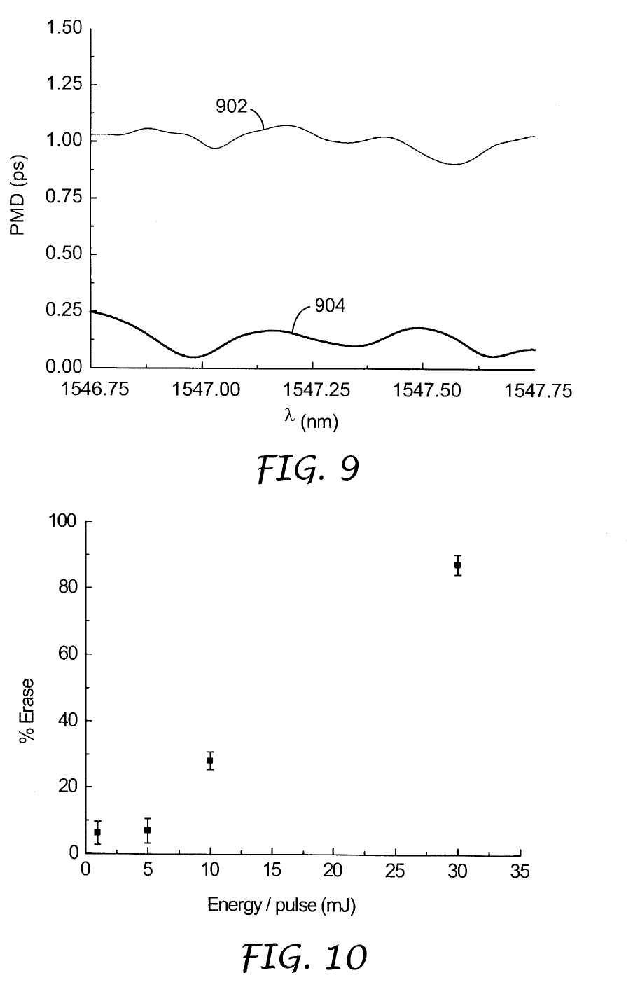

Grating #2 was exposed to 30 mJ pulses for duration of 60 minutes. The PMD measured using the OVA prior to exposure is shown as curve 902 in FIG. 9, within the bandwidth of the grating. The measurement was carried out in the high-resolution mode with 1.35 pm resolution bandwidth and then a 160 pm filter was applied to get the behavior of the first order PMD value of the device. The PMD value measured after the exposure to the photo-reducing light is shown as curve 904. The first-order PMD of the grating decreased from approximately Ips to approximately 0.12 ps, a reduction of approximately 90%, after the exposure. The PMD of gratings, which were not exposed, remained the same at approximately 1 ps.

Thus, the technique is useful for producing a PMD value of less than 1 ps in a chirped fiber grating having a bandwidth of at least 1 nm and/or a reflectivity in excess of 50%. The technique may also be used to produce a PMD value of less than 0.75 ps, less than 0.5 ps and less than 0.25 ps in a fiber grating having a bandwidth of at least 1 nm, as is shown below. In addition, the technique may be used for reducing the PMD where the peak reflectivity of the grating is at least 80%, and in some cases at least 90%.

Using the PMD measurements made before and after the photo-reduction exposure (as mentioned in Table I), one may calculate the percentage PMD reduction for the different conditions. FIG. 10 shows a curve relating the percentage of reduction in PMD to the pulse energy. Each data point is an average for 3 gratings, exposed under identical conditions. From the behavior illustrated in FIG. 10, it is clear that the greater the photon flux in the fiber core, the better is the photo-reduction process, suggesting a multi-photon mechanism.

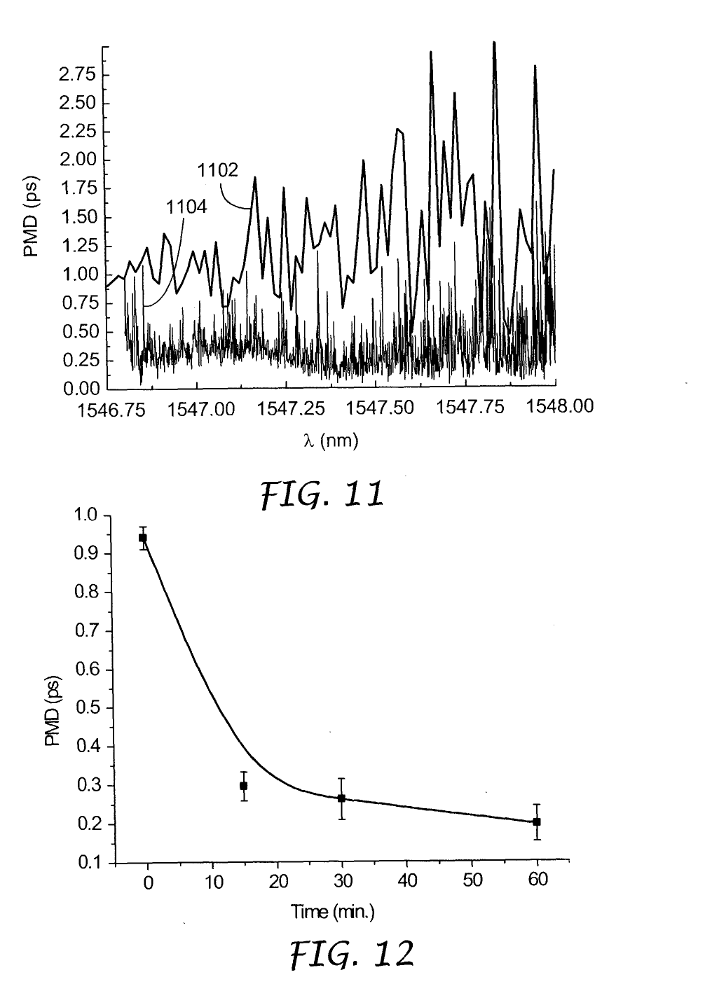

The measurements of PMD were confirmed by repeating the procedure for a different grating and also by measuring the PMD of the grating using the 4-point MPS method using smaller step sizes of 16 pm and 1 pm. The results of the four-point MPS method are presented in FIG. 11. Curve 1102 shows the PMD measured before exposure and curve 1104 shows the PMD measured after the exposure. A dramatic reduction in the PMD value of the grating is evident from these measurements also. In summary, it has been shown that the illumination of a waveguide, which includes a UV-written refractive structure, with light that can be absorbed by the Ge-1 defect leads to a reduction in the birefringent characteristics of the waveguide. In particular, the birefringence of the structure and the PMD of the structure are reduced. It is believed that the reduction in birefringent characteristics occurs with photo-reducing of the Ge-1 absorption.

The waveguide may be illuminated from the side or along its core. Illumination along the core leads to more efficient photo-bleaching of the defect. The absorption of the photo-reducing light may be single photon or multi-photon, and a wide variety of wavelengths may be used. The reduction of the birefringent characteristics varies approximately linearly with duration of exposure and energy of the exposing light.

The PMD of chirped Bragg gratings was also measured before and after the photo-reducing exposure for fixed pulse energy as a function of time. FIG. 12 is a plot showing the reduction in the PMD of CFG, measured using OVA 1500 (LUNA Technologies Inc., VA, USA). The bandwidth of the CFG was 1.5 nm with 420 ps/nm dispersion, corresponding to a UV-exposed fiber length of approximately 7 cm. The PMD of the CFG before exposure was approximately 1 ps, which after exposure to 532 nm laser light with 40 mJ of pulse energy reduces to 0.3 ps in 15 minutes and to 0.26 ps and 0.2 ps upon continuing the exposure for 30 minutes and 60 minutes, respectively. Comparing the results with previous measurements further confirms that increasing the pulse energy of light launched into the fiber speeds-up the photo-reduction, suggesting a multi-photon process.

The waveguides treated according to the present invention are different from those treated in some other manner to reduce or avoid the birefringent effects that arise when UV-writing a refractive structure. One of the other approaches used for reducing birefringent effects includes illuminating the waveguide from different directions in order to reduce the asymmetry that arises from UV-inscribing the structure by illuminating from one side. This requires careful registration of the waveguide to the UV-writing pattern when rotating the waveguide to a new illumination position. Furthermore, this approach does not avoid or reduce the UV-absorption that arises from the Ge-1 defect: it simply makes the presence of the defect more uniform.

Another approach to reduce the birefringent effects that arise when UV-writing a refractive structure includes altering the polarization of the UV-inscribing beam. This is understood to align the dipoles associated with the defect in a manner that reduces birefringence. This approach does not avoid or reduce the UV-absorption that arises from the Ge-1 defect.

In contrast with other approaches, the present approach not only reduces birefringent effects, but also reduces the UV-absorption associated with the Ge-1 defect in the waveguide. The UV-absorption in the waveguide may be measured spectroscopically. Both the magnitude of the UV-absorption and the shape of the UV-absorption are affected by the photo-reducing process.

As has already been mentioned, the absorption due to the presence of Ge-1 defects in the waveguide exposed to UV light has a maximum at approximately 280 nm and the absorption tail extends into the visible and near infrared (NIR) wavelength regions. Changes in the absorption characteristics, equivalently the attenuation (in dB/m), in the visible and NIR wavelength regions can be monitored using a cutback measurement. The measurement requires launching light from a broadband light source (λ is approximately 0.4 μm-1.8 μm) (AQ-4303 B., Ando Electric Co., Ltd. Tokyo, Japan) through the fiber and measuring the changes over distance using an optical spectrum analyzer (AQ 6315-A, Ando Electric Co., Ltd. Tokyo, Japan). The method known as the cutback method involves coupling the fiber to the source and measuring the power out of the far end. The fiber is then cut near the light source and the power measured again. By knowing the power at the source (P_{S}) and at the end (P_{E}) of the fiber and the length of the fiber (L), the attenuation coefficient (in dB/m) can be determined by calculating [(P_{E}—P_{S})/L].

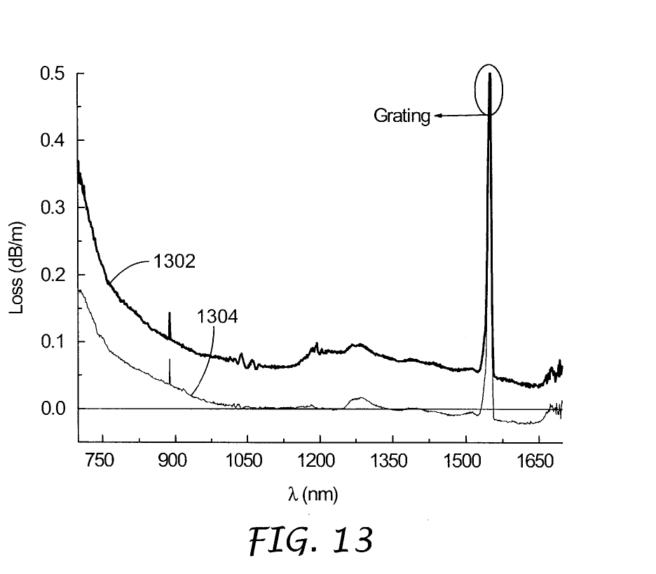

One example of the change in the fiber absorption that results from exposure to the photo-reducing light is presented in FIG. 13. Curve 1302 shows the absorption spectrum before exposure and curve 1304 shows the UV absorption after exposure to the photo-reducing light. To achieve the reduction in the absorption features of the fiber, the fiber was exposed to circularly polarized 514.5 nm light from Ar⁺ laser with an average power of 500 mW launched in the core of the fiber for approximately 2 hours. As can be seen, the photo-reducing process results in significant-reduction of the absorption tail in the visible and NIR wavelength regions. Another important result is that the absorption at the signal wavelength, typically in the range 1500 nm-1600 nm for optical communications, is reduced by about 0.1 dB/m compared with the grating-written fiber before photo-reduction.

Another approach useful for measuring the presence of the birefringent defects is to perform an atomic force microscopy (AFM) measurement across the waveguide. This technique was discussed above with respect to Example 4.

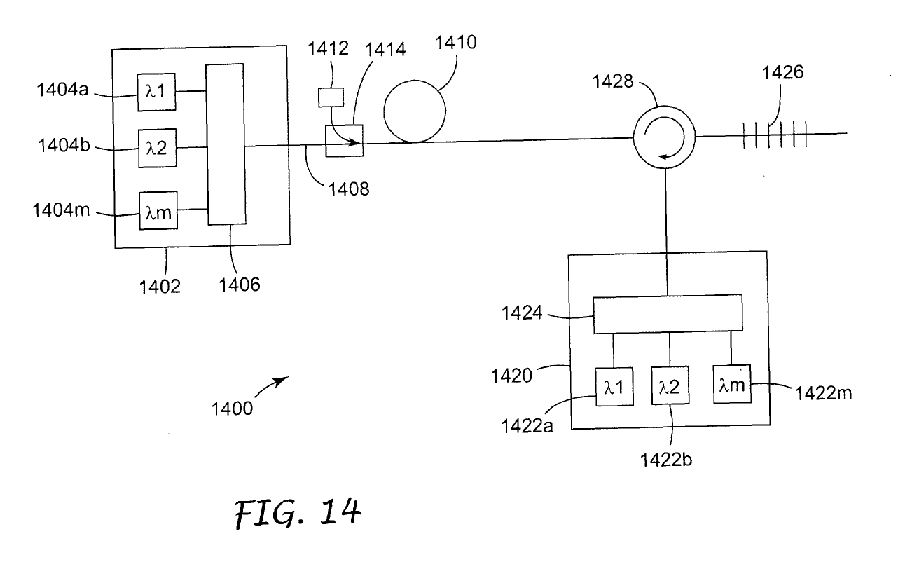

Waveguide devices according to the present invention may be used in many different types of systems. A low PMD fiber grating is particularly useful in an optical communications system, for example in a dispersion compensating grating. One embodiment of an optical communications system 1400 that includes a dispersion-compensating grating is schematically illustrated in FIG. 14. The system 1400 has an optical transmitter 1402 that may include light sources 1404a, 1404b, . . . , 1404m operating at different wavelengths λ1, λ2, . . . , λm, corresponding to different optical channels. The light sources 1404a-1404m are typically externally modulated, single frequency lasers operating at about 1550 nm, although they may be internally modulated and may also operate at different wavelengths. The light from the light sources 1404a-1404m is combined in an optical combiner unit 1406, which may include one or more wavelength division multiplexing (WDM) elements. The combined signal is launched into a fiber optic link 1408.

The fiber link 1408 may include one or more fiber amplifier units 1410, for example rare earth-doped fiber amplifiers, Raman fiber amplifiers or a combination of rare earth-doped and Raman fiber amplifiers. The pump light may be introduced to the fiber amplifier 1410 from a pump unit 1412 via a coupler 1414. Optical isolators (not shown) may be positioned along the fiber link 1408 to prevent light from passing in the backwards direction. For example isolators may be positioned on either side of the amplifier 1410 to reduce the possibility of backscattered light, propagating towards the transmitter 1402, or from being amplified in the amplifier 1410.

The fiber optic link 1408 may be coupled to a receiver 1420, for example a multichannel receiver. Multichannel light enters the receiver 1420 and is split up into different channels corresponding to different wavelengths. In the illustrated embodiment, the receiver 1420 includes detectors 1422a, 1422b, . . . , 1422m corresponding to different optical channels at wavelengths λ1, λ2, . . . , λm. A wavelength splitting unit 1424, for example using a wavelength division demultiplexing elements, may be used to split the incoming light into the different wavelength components, and to direct the separated light components to their respective detectors.

In the illustrated embodiment, a dispersion compensating fiber grating 1426 is disposed to compensate for the dispersion of the light propagating along the fiber link 1408 from the transmitter 1402 to the receiver 1420. The light propagating along the fiber link 1408 is directed to the dispersion compensating fiber grating 1426 via a circulator 1428, which directs the light reflected by the grating 1426 to the receiver 1420. Dispersion compensation may be provided at any point along the fiber link 1408, and is not restricted to being provided just before the detector.

It will be appreciated that other arrangements of fiber gratings may be used for add/drop multiplexers, band-pass filters, single frequency reflectors, and the like.

As noted above, the present invention is applicable to techniques for reducing birefringence and PMD in UV-inscribed structures in waveguides, and is believed to be particularly useful for reducing PMD in FBGs. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A method for reducing birefringent characteristics of a refractive structure written in a waveguide, comprising:
providing the waveguide with the refractive structure written in the waveguide, the refractive structure having an associated germanium-related defect; and
exposing the refractive structure to photo-reducing light absorbable by the germanium-related defect so as to reduce a birefringent characteristic of the refractive structure.

2. A method as recited in claim 1, wherein providing the waveguide includes side-illuminating the waveguide with UV light at a first wavelength to write the refractive structure in the waveguide, the refractive index structure having a non-uniform refractive index characteristic across the waveguide.

3. A method as recited in claim 2, wherein the photo-reducing light has a wavelength different from the first wavelength.

4. A method as recited in claim 1, wherein exposing the refractive structure with the photo-reducing light results in randomizing directions of dipoles of defects that arise from writing the refractive structure.

5. A method as recited in claim 1, wherein exposing the refractive structure with the photo-reducing light results in a reduction in light absorption in the waveguide for ultraviolet, visible and infrared wavelengths.

6. A method as recited in claim 1, wherein the refractive structure is a grating in the waveguide.

7. A method as recited in claim 6, wherein the grating is a fiber Bragg grating.

8. A method as recited in claim 7, wherein the fiber Bragg grating is a chirped fiber grating.

9. A method as recited in claim 7, wherein the chirped fiber grating is a dispersion-compensation grating.

10. A method as recited in claim 7, wherein the fiber Bragg grating is an unchirped fiber grating.

11. A method as recited in claim 6, wherein the grating is a long period fiber grating.

12. A method as recited in claim 1, wherein the waveguide is an optical fiber.

13. A method as recited in claim 1, wherein exposing the refractive structure includes guiding the photo-reducing light along the waveguide.

14. A method as recited in claim 1, wherein the photo-reducing light has a wavelength such that the germanium-related defect undergoes a two-photon absorption of the photo-reducing light.

15. A method as recited in claim 1, wherein the photo-reducing light has a wavelength such that the germanium-based defect undergoes a multiple photon absorption of the photo-reducing light.

16. A method as recited in claim 1, wherein the exposing is performed until a desired value of the birefringent characteristic is achieved.

17. A method as recited in claim 1, further comprising setting the photo-reducing light in a desired polarization state before exposing the refractive structure to the photo-reducing light.

18. A method as recited in claim 17, wherein the desired polarization state is circularly polarized.

19. A method as recited in claim 17, wherein the desired polarization state is depolarized.

20. A method as recited in claim 1, wherein exposing the refractive structure to the photo-reducing light includes exposing the refractive structure to pulsed laser light.

21. A method as recited in claim 1, wherein exposing the refractive structure to the photo-reducing light includes exposing the refractive structure to continuous laser light.

22. An optical waveguide device, comprising:
an optical waveguide; and
a refractive structure written in a portion of the waveguide containing a photosensitive species, the refractive structure being birefringence-reduced using photo-reducing light.

23. A device as recited in claim 22, wherein the optical waveguide is an optical fiber.

24. A device as recited in claim 23, wherein the optical fiber is a single mode optical fiber.

25. A device as recited in claim 22, wherein the refractive structure is a long period grating.

26. A device as recited in claim 22, wherein the refractive index is a Bragg grating.

27. A device as recited in claim 26, wherein the Bragg grating is a chirped Bragg grating.

28. A device as recited in claim 27, wherein the Bragg grating has a polarization mode dispersion of no more than 1 ps.

29. A device as recited in claim 27, wherein the chirped Bragg grating is a linearly chirped Bragg grating.

30. A device as recited in claim 27, wherein the chirped Bragg grating is a nonlinearly chirped Bragg grating.

31. A device as recited in claim 27, wherein the chirped Bragg grating is a dispersion-compensation grating.

32. An optical waveguide device, comprising:
an optical waveguide; and
a chirped Bragg grating in the waveguide having a polarization mode dispersion of not more than 1 ps and at least one of a bandwidth of at least 1 nm and a maximum reflectivity of at least 50%.

33. A device as recited in claim 32, wherein the maximum reflectivity is at least 80%.

34. A device as recited in claim 32, wherein the maximum reflectivity is at least 90%.

35. A device as recited in claim 32, wherein the polarization mode dispersion is no more than 0.75 ps.

36. A device as recited in claim 32, wherein the polarization mode dispersion is no more than 0.5 ps.

37. A device as recited in claim 32, wherein the polarization mode dispersion is no more than 0.25 ps.

38. A device as recited in claim 32, wherein the maximum reflectivity is at least 80%.

39. A device as recited in claim 32, wherein the maximum reflectivity is at least 90%.

40. A device as recited in claim 32, wherein the polarization mode dispersion is no more than 0.75 ps.

41. A device as recited in claim 32, wherein the polarization mode dispersion is no more than 0.5 ps.

42. A device as recited in claim 32, wherein the polarization mode dispersion is no more than 0.25 ps.

43. A device as recited in claim 32, wherein the optical waveguide is an optical fiber.

44. A device as recited in claim 43, wherein the optical fiber is a single mode optical fiber.

45. A device as recited in claim 32, wherein the chirped Bragg grating has a linear chirp.

46. A device as recited in claim 32, wherein the chirped Bragg grating has a nonlinear chirp.

47. An optical communications system, comprising:
an optical transmitter transmitting output light;
a fiber optic link coupled to carry the output light from the optical transmitter; and
a waveguide grating coupled to the fiber optic link to reflect at least a portion of the output light, the waveguide grating including a refractive structure written in a portion of the waveguide containing a photosensitive species, the refractive structure being birefringence-reduced using photo-reducing light.

48. A system as recited in claim 47, wherein the optical transmitter includes multiple light sources generating light at multiple wavelengths and also includes light combining units to combine the light at the multiple wavelengths.

49. A system as recited in claim 47, further comprising an optical receiver unit to receive at least a portion of the output light.

50. A system as recited in claim 49, wherein the optical receiver includes detectors for detecting light at different wavelengths, and also includes demultiplexing units for separating light signals at the different wavelengths.

51. A system as recited in claim 47, further comprising one or more optical amplifier units disposed along the fiber optic link.

52. A system as recited in claim 47, wherein the waveguide grating is a chirped fiber grating.

53. A system as recited in claim 52, further comprising a circulator unit, the chirped fiber grating being coupled to the circulator unit to receive light from the optical transmitter.
